(19) United States
(12) Patent Application Publication
(10) Pub. No.: US 2016/0223390 A1
(43) Pub. Date: Aug. 4, 2016

(54) WIRELESS SENSING DEVICE

(71) Applicant: Wistron NeWeb Corp., Hsinchu (TW)

(72) Inventor: Yung-Cheng Lin, Hsinchu (TW)

(21) Appl. No.: 14/864,849

(22) Filed: Sep. 24, 2015

(30) Foreign Application Priority Data
Feb. 4, 2015 (TW) 104103717

(51) Int. Cl. G01H 11/06; G01P 15/08

(52) U.S. Cl. CPC G01H 11/06; G01P 15/0802

(57) ABSTRACT

A wireless sensing device including a vibration plate, an antenna, a sensor, an energy harvesting circuit and a data processing circuit is provided. The antenna and the sensor are disposed on the vibration plate. The sensor generates a sensing data according to the vibration of the vibration plate. The energy harvesting circuit generates an electrical energy in response to the vibration of the vibration plate. The data processing circuit is coupled to the sensor and the antenna, and the data processing circuit is operated by the electrical energy to store the sensing data, or to transmit the sensing data through the antenna.

### CROSS-REFERENCE TO RELATED APPLICATION

This application claims the priority benefit of Taiwan application serial no. 104103717, filed on Feb. 4, 2015. The entirety of the above-mentioned patent application is hereby incorporated by reference herein and made a part of this specification.

### BACKGROUND OF THE INVENTION

1. Field of the Invention

The invention relates to a sensing technology and more particularly relates to a wireless sensing device.

2. Description of Related Art

In surveying various resources and environment on Earth, wireless sensing devices all play an indispensable role. Generally, researchers dispose a large quantity of wireless sensing devices in the environment desired to be surveyed so as to perform long-term data collection. The wireless sensing devices then return the collected sensing data back to control centers on land, thereby allowing researchers to analyze or adjust the wireless sensing devices in response to the actual state of the environment to be surveyed. Therefore, concerning long-term surveying and data analysis, the way of managing the power of the devices and enhancing the accuracy of the sensing data is always a major subject in terms of the design of wireless sensing devices.

### SUMMARY OF THE INVENTION

The invention provides a wireless sensing device, which generates electrical energy through an energy harvesting circuit and detects a change in the environment sensed through a sensor, thereby effectively managing the power of the wireless sensing device and enhancing the accuracy of sensing data.

The wireless sensing device of the invention includes a vibration plate, an antenna, a sensor, an energy harvesting circuit and a data processing circuit. The antenna and the sensor are disposed on the vibration plate. The sensor generates a sensing data according to the vibration of the vibration plate. The energy harvesting circuit generates an electrical energy in response to the vibration of the vibration plate. The data processing circuit is coupled to the sensor and the antenna, and the data processing circuit is operated by the electrical energy to store the sensing data, or to transmit the sensing data through the antenna.

In an embodiment of the invention, the wireless sensing device enables the data processing circuit through the electrical energy, thereby allowing the data processing circuit to be switched between a detection mode and a transmission mode. In addition, under the detection mode, the data processing circuit activates the sensor through the electrical energy and stores the sensing data generated from the sensor. Under transmission mode, the data processing circuit transmits the sensing data through the antenna.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of a wireless sensing device according to an embodiment of the invention.

FIG. 2 is a schematic block diagram of an energy harvesting circuit according to an embodiment of the invention.

FIG. 3 is a schematic block diagram of a data processing circuit according to an embodiment of the invention.

FIGS. 4 and 5 are a front view and a side view illustrating a configuration structure of an antenna and a sensor respectively according to an embodiment of the invention.

FIGS. 6 and 7 are a front view and a side view illustrating a configuration structure of an antenna and a sensor respectively according to another embodiment of the invention.

### DESCRIPTION OF THE EMBODIMENTS

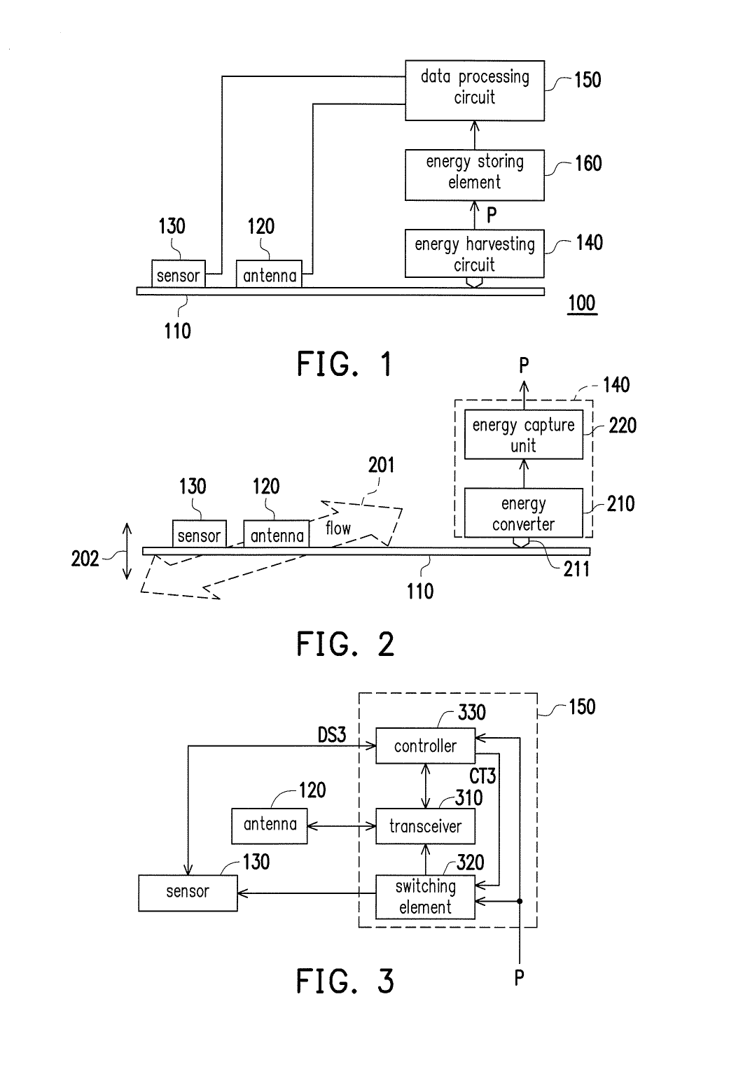

FIG. 1 is a schematic block diagram of a wireless sensing device according to an embodiment of the invention. As shown in FIG. 1, the wireless sensing device 100 includes a vibration plate 110, an antenna 120, a sensor 130, an energy harvesting circuit 140 and a data processing circuit 150. The antenna 120 and the sensor 130 are disposed on the vibration plate 110. Moreover, the sensor 130 generates a sensing data according to a vibration of the vibration plate 110.

For instance, the sensor 130 can be a micro-electro-mechanical system (MEMS) sensor, in which the MEMS sensor may include a gyroscope and an accelerometer, etc. Thus, when the vibration plate 110 generates the vibration in response to the environment sensed, the sensor 130 detects an amount of change in vibration frequency, and acceleration, etc. of the vibration plate 110. The sensing data generated by the sensor 130 therefore includes vibration frequency data and acceleration data, etc. In other words, with the vibration of the vibration plate 110, the sensor 130 disposed on the vibration plate 110 detects a change in the environment sensed, and thus enhancing the accuracy of the sensing data.

The energy harvesting circuit 140 is connected to the vibration plate 110 and generates an electrical energy P in response to the vibration of the vibration plate 110. In other words, the energy harvesting circuit 140 converts mechanical energy in the environment into electrical energy, thereby providing the electrical energy P (such as a power source, a power signal, or a power voltage, etc.) required by the wireless sensing device 100. Thus, the wireless sensing device 100 self-generates the electrical energy P needed by the internal elements (such as the sensor 130 and the data processing circuit 150) through the energy harvesting circuit 140, thereby effectively managing a power of the wireless sensing device 100.

For instance, FIG. 2 is a schematic block diagram of an energy harvesting circuit according to an embodiment of the invention. The energy harvesting circuit 140 includes an energy converter 210 and an energy capture unit 220. Moreover, when the sensing environment changes, such as a flowing fluid (such as air and water) in the environment to be sensed, the flow 201 of the flowing fluid drives the vibration plate 110 to generate a back and forth vibration along a direction 202. Furthermore, the energy converter 210 has a contact portion 211. When vibration is generated by the vibration plate 110, the stress generated from the collision between the vibration plate 110 and the contact portion 211 of the energy converter 210 will be received by the energy converter 210 thereby deforming.

In other words, the vibration of the vibration plate 110 provides a stress, namely mechanical energy, to the energy converter 210, and the energy converter 210 converts that stress into an electrical signal, namely electrical energy. In addition, the energy capture unit 220 adjusts the electrical signal, so as to convert the electrical signal into the electrical energy P required by the wireless sensing device 100. For instance, the energy capture unit 220 includes, for example, a full bridge rectifier and a filter capacitor in order to filter and rectify the electrical signal, thereby generating the stable electrical energy P.

Still referring to FIG. 1, the data processing circuit 150 is electrically connected to the antenna 120 and the sensor 130 disposed on the vibration plate 110. In addition, the data processing circuit 150 is operated by the electrical energy P to selectively store the sensing data or to transmit the sensing data through the antenna 120. In other words, the way the sensing data being processed (i.e., being stored or transmitted through the antenna) is controlled in accordance with the electrical energy P as an electric signal. In an embodiment, the wireless sensing device 100 further includes an energy storing element 160, in which the energy storing element 160 can be a battery and can be used to store the electrical energy P.

It is worth noting that, in regard with the management of power, the wireless sensing device 100 enables the data processing circuit 150 through the electrical energy P, thereby allowing the data processing circuit 150 to be selectively switched between a detection mode and a transmission mode. Under the detection mode, the data processing circuit 150 activates the sensor 130 according to the electrical energy P, and stores the sensing data generated from the sensor 130. While the data processing circuit 150 is operating in the transmission mode, the data processing circuit 150 transmits the sensing data through the antenna 120.

For instance, FIG. 3 is a schematic block diagram of a data processing circuit according to an embodiment of the invention. The data processing circuit 150 includes a transceiver 310, a switching element 320, and a controller 330. The wireless sensing device 100 enables the controller 330 through the electrical energy P, thereby allowing the data processing circuit 150 to be selectively switched between the detection mode and the transmission mode. Further, the switching element 320 receives the electrical energy P and selectively transmits the electrical energy P to the transceiver 310 or the sensor 130 according to a control signal CT3 generated by the controller 330.

More specifically, while the data processing circuit 150 is operating in the detection mode, the controller 330 controls the switching element 320 by using the control signal CT3 having a first level, such that the switching element 320 transmits the electrical energy P to the sensor 130 to activate the sensor 130. Meanwhile, the sensor 130 is being operated by the electrical energy P, so as to generate a sensing data DS3. Whereas, while operating in the detection mode, the controller 330 stores the sensing data DS3 from the sensor 130 in order to collect other sensing data. In another aspect, while operating in the transmission mode, the controller 330 controls the switching element 320 by using the control signal CT3 which has a second level, such that the switching element 320 transmits the electrical energy P to the transceiver 310 to activate the transceiver 310. At the mean time, the transceiver 310 is being operated by the electrical energy P, so as to transmit the sensing data DS3 through the antenna 120.

In other words, in regard with the management of the power, the wireless sensing device 100 first activates the controller 330 in the data processing circuit 150 through the electrical energy P, and then activates the sensor 130 or the transceiver 310 through the controller 330, so as to allow the wireless sensing device 100 to selectively perform a sensing operation in the detection mode or a transmission operation in the transmission mode. Moreover, while the energy harvesting circuit is 140 continuously supplying the electrical energy P, the wireless sensing device 100 alternately and repeatedly performs the sensing operation in the detection mode and the transmission operation in the transmission mode. In addition, when the energy harvesting circuit 140 stops generating the electrical energy P, the data processing circuit 150 switches to a sleep mode to reduce power consumption of the wireless sensing device 100. In other words, the wireless sensing device 100 further manages the power through the switching of the modes.

It is worth noting that, in practice, the wireless sensing device 100 can be regarded as a data transmission relay station. Therefore, when the wireless sensing device 100 is applied to a wireless local area network, the controller 330 can be a network processing unit (NPU). Additionally, the transceiver 310 may transmit the sensing data DS3 through wireless communication protocols, such as wireless local area network, Bluetooth, Zigbee, etc., in the IEEE 802.11 standard.

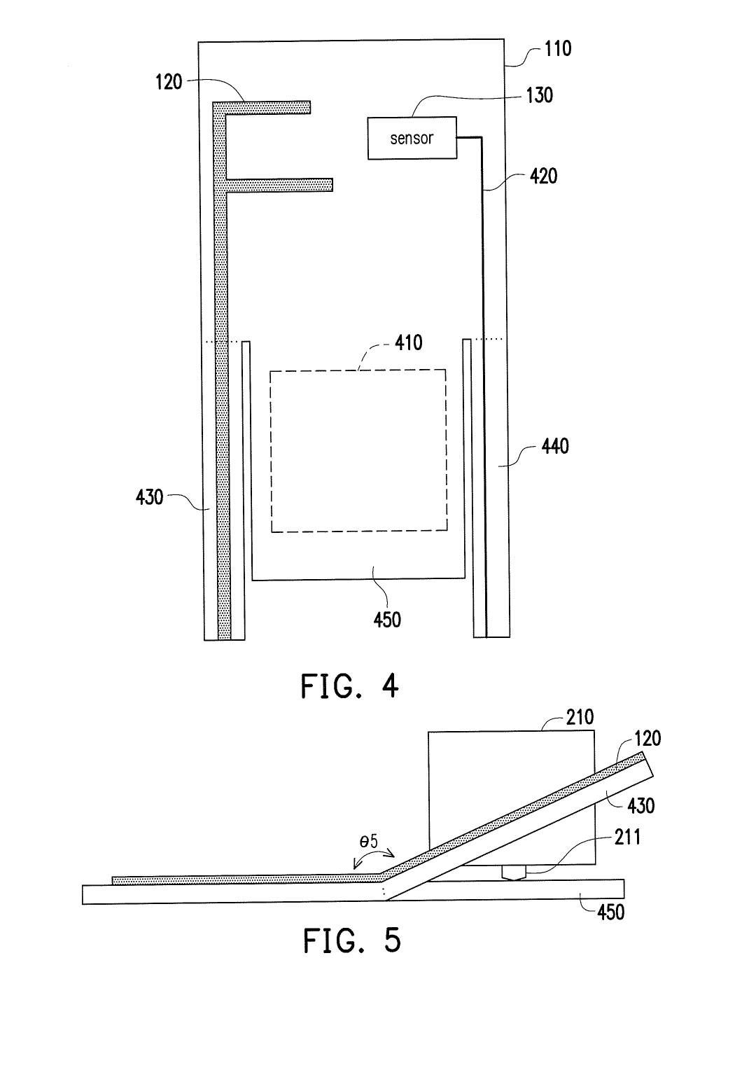

FIGS. 4 and 5 are a front view and a side view illustrating a configuration structure of an antenna and a sensor, respectively, according to an embodiment of the invention. The energy converter 210 is positioned above the vibration plate 110, and an orthogonal projection of the energy converter 210 on the vibration plate 110 is shown as the broken line 410. Besides, the antenna 120 can be a printed antenna that is printed on the vibration plate 110 through a manner of printing. In addition, as shown in FIG. 4, an orthogonal projection of the printed antenna on the vibration plate 110 and the orthogonal projection of the energy converter 210 on the vibration plate 110 do not overlap with each other, so as to prevent the printed antenna colliding with the energy converter 210, thereby preventing the printed antenna from being deformed or parted.

In another aspect, the data processing circuit 150 is electrically connected to the sensor 130 through a wire 420 disposed on the vibration plate 110. Moreover, an orthogonal projection of the wire 420 on the vibration plate 110 and the orthogonal projection of the energy converter 210 on the vibration plate 110 do not overlap with each other, so as to prevent the wire 420 from colliding with the energy converter 210 and thus being deformed or parted. The orthogonal projection means that the projection lines of the wire 420 and the energy converter 210 are perpendicular to a projection plane of the vibration plate 110. That is, the wire 420 is projected on the projection plane of the vibration plate 110 along a direction perpendicular to the projection plane to form the orthogonal projection on the vibration plate 110. Similarly, the energy converter 210 is projected on the projection plane of the vibration plate 110 along the direction perpendicular to the projection plane to form the orthogonal projection on the vibration plate 110.

In addition, the antenna 120 and the wire 420 are disposed at two sides of the vibration plate 110 so as to electrically connect to the data processing circuit 150. For instance, the two sides of the vibration plate 110 have a bent portion 430 and a bent portion 440, respectively. The bent portion 430 and the bent portion 440 respectively form an angle 05 with a body portion 450 of the vibration plate 110. Moreover, a part of the antenna 120 is located at the bent portion 430 of the vibration plate 110, and a part of the wire 420 is located at the bent portion 440 of the vibration plate 110. It is worth noting that the data processing circuit 150 is positioned above the body portion 450 of the vibration plate 110. For instance, the data processing circuit 150 can be positioned above or within the energy converter 210. Moreover, the antenna 120 disposed at the bent portion 430 and the antenna 120 disposed at the body portion 450 are respectively positioned on different horizontal planes through adjustment of the angle θ5. Therefore, disposing a part of the antenna 120 on the bent portion 430 facilitates the electrical connection between the antenna 120 and the data processing circuit 150. Similarly, disposing a part of the wire 420 on the bent portion 440 of the vibration plate 110 facilitates the electrical connection between the wire 420 and the data processing circuit 150.

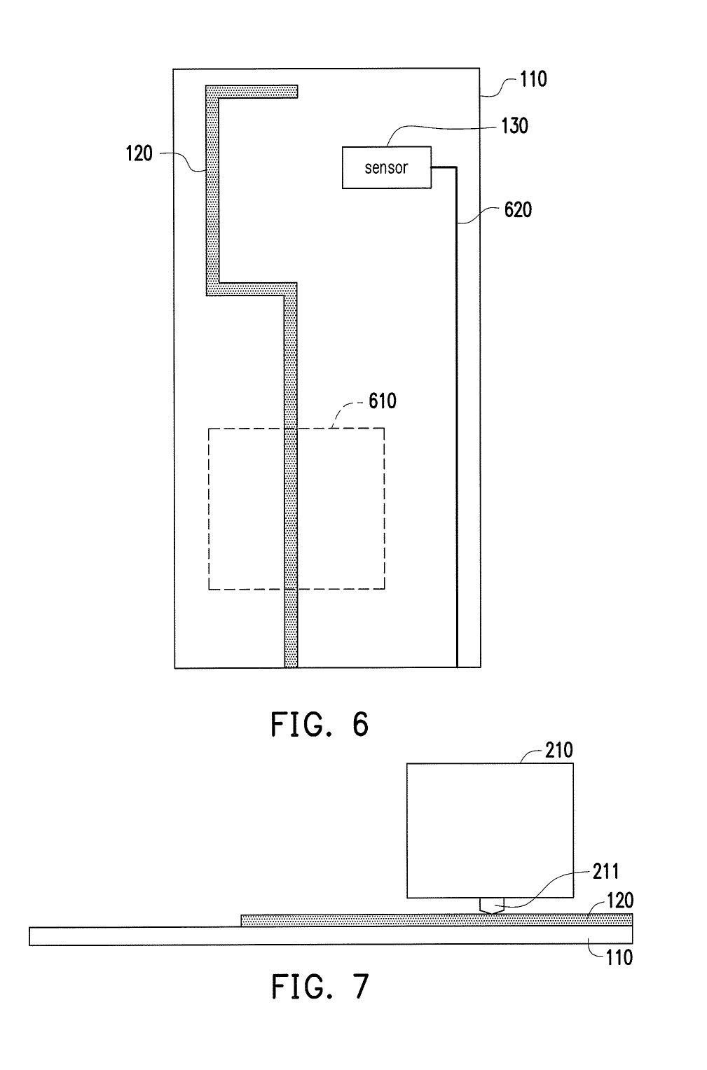

FIGS. 6 and 7 are a front view and a side view illustrating a configuration structure of an antenna and a sensor, respectively, according to another embodiment of the invention. The energy converter 210 is positioned above the vibration plate 110, and an orthogonal projection of the energy converter 210 on the vibration plate 110 is shown as the broken line 610. Moreover, the antenna 120 can be a stamped antenna. In other words, the antenna 120 can be formed metal components being made via a stamping process, thereby strengthening the structure of the antenna 120. Therefore, in practical applications, the energy converter 210 can be directly colliding with the stamped antenna.

For instance, referring to FIGS. 6 and 7, the stamped antenna is directly fixed on the vibration plate 110 and faces the energy converter 210. In other words, the orthogonal projections of the stamped antenna energy converter 210 on the vibration plate 110 are partially overlapped. In practical applications, as shown in FIG. 7, the contact portion 211 of the energy converter 210 directly collides with the stamped antenna. While comparing to the printed antenna in FIGS. 4 and 5, there is no need to avoid the collision between the energy converter 210 and the stamped antenna, the volume of the wireless sensing device 100 can be reduced and thereby miniaturized. In another aspect, the data processing circuit 150 is electrically connected to the sensor 130 through a wire 620 disposed on the vibration plate 110. The orthogonal projection of the wire 620 and the energy converter 210 on the vibration plate 110 do not overlap with each other, so as to prevent the collision between the wire 620 and the energy converter 210, that causes deformation or fracture.

In summary of the above, the wireless sensing device of the invention generates the electrical energy through the energy harvesting circuit in response to the vibration of the vibration plate. In other words, the wireless sensing device self-generates the electrical energy through the energy harvesting circuit and effectively manages the power by switching to different modes according to the electrical energy. Moreover, the sensor in the wireless sensing device is disposed on the vibration plate, such that with the vibration of the vibration plate, the sensor disposed on the vibration plate detects a change in the sensing environment, and thus enhancing the accuracy of the sensing data.

Although the present invention has been described with reference to the above embodiments, it will be apparent to those skilled in the art that various modifications and variations can be made to the disclosed embodiments without departing from the scope or spirit of the invention.

What is claimed is:

1. A wireless sensing device, comprising:
a vibration plate;
an antenna, disposed on the vibration plate;
a sensor, disposed on the vibration plate and generating a sensing data according to the vibration of the vibration plate;
an energy harvesting circuit, generating an electrical energy in response to the vibration of the vibration plate; and
a data processing circuit, coupled to the sensor and the antenna, wherein the data processing circuit is operated by the electrical energy to store the sensing data, or to transmit the sensing data through the antenna.

2. The wireless sensing device according to claim 1, further comprising an energy storing element storing the electrical energy.

3. The wireless sensing device according to claim 1, wherein the wireless sensing device enables the data processing circuit through the electrical energy, thereby allowing the data processing circuit to be switched between a detection mode and a transmission mode, wherein under the detection mode, the data processing circuit activates the sensor through the electrical energy and stores the sensing data generated from the sensor, whereas under the transmission mode, the data processing circuit transmits the sensing data through the antenna.

4. The wireless sensing device according to claim 3, wherein when the energy harvesting circuit stops generating the electrical energy, the data processing circuit is switched to a sleep mode.

5. The wireless sensing device according to claim 1, wherein the data processing circuit comprises:
a transceiver, electrically connected to the antenna;
a switching element, receiving the electrical energy; and
a controller, wherein the wireless sensing device enables the controller through the electrical energy, thereby allowing the data processing circuit to be switched between a detection mode and a transmission mode, wherein under the detection mode, the controller drives the switching element to transmit the electrical energy to the sensor, and the controller stores the sensing data from the sensor, whereas under the transmission mode, the controller drives the switching element to transmit the electrical energy to the transceiver transmitting the sensing data through the antenna.

6. The wireless sensing device according to claim 1, wherein the energy harvesting circuit comprises:
an energy converter, generating an electrical signal in response to the vibration of the vibration plate; and
an energy capture unit, converting the electrical signal into the electrical energy.

7. The wireless sensing device according to claim 6, wherein the antenna is a printed antenna, and an orthogonal projection of the printed antenna on the vibration plate and an orthogonal projection of the energy converter on the vibration plate do not overlap with each other.

8. The wireless sensing device according to claim 7, wherein the vibration plate comprises at least one bent portion and a body portion, the at least one bent portion and the body portion form an angle, and a part of the printed antenna is disposed at the at least one bent portion.

9. The wireless sensing device according to claim 6, wherein the antenna is a stamped antenna, and an orthogonal projection of the stamped antenna on the vibration plate and an orthogonal projection of the energy converter on the vibration plate are partially overlapped.

10. The wireless sensing device according to claim 6, wherein the data processing circuit is electrically connected to the sensor through a wire disposed on the vibration plate, wherein an orthogonal projection of the wire on the vibration plate and an orthogonal projection of the energy converter on the vibration plate do not overlap with each other.

11. The wireless sensing device according to claim 1, wherein the sensor is a micro-electro-mechanical system sensor and the sensing data comprises acceleration data and vibration frequency data.
